(19) United States
(12) Patent Application Publication
(10) Pub. No.: US 2026/0292921 A1
(43) Pub. Date: Sep. 24, 2026

(54) BASE STATION INTRINSIC INTERFERENCE MITIGATION IMPLEMENTATION

(71) Applicant: T-MOBILE INNOVATIONS LLC, Overland Park, KS (US)

(72) Inventor: Chad Chun Fai AU, Kirkland, WA (US)

(21) Appl. No.: 19/083,191

(22) Filed: Mar. 18, 2025

(51) Int. Cl. H04W 76/28; H04W 52/24; H04W 52/36

(52) U.S. Cl. CPC H04W 76/28; H04W 52/243; H04W 52/367

(57) ABSTRACT

Systems and methods are provided for dynamically deactivating and reactivating a radio at a cell site based on radio frequency interference. Initially, a radar presence detector of the cell site detects a waveform. The radar presence detector determines the waveform is not a wireless traffic waveform. Based on this determination, a dynamic power module of the cell site dynamically deactivates or adjust power of at least one radio of the at least one antenna of the cell site. In aspects, the radar presence detector determines the waveform is a radar waveform by comparing frequency bandwidth of the waveform to the wireless traffic waveform or pulse characteristics of the waveform to the wireless traffic waveform.

### SUMMARY

A high-level overview of various aspects of the invention are provided here for that reason, to provide an overview of the disclosure and to introduce a selection of concepts that are further described in the detailed-description section below. This summary is not intended to identify key features or essential features of the claimed subject matter, nor is it intended to be used as an aid in isolation to determine the scope of the claimed subject matter.

In brief and at a high level, aspects are provided for dynamically deactivating and reactivating cell sites based on a radio frequency interference. More particularly, aspects are provided for recognizing, at the base band unit, a radar pulse waveform, as differentiated from normal wireless traffic. To do so, initially, a radar presence detector of the cell site detects a waveform. The radar presence detector determines the waveform is not a wireless traffic waveform. Based on this determination, a dynamic power module of the cell site dynamically deactivates or adjusts power of at least one radio of the at least one antenna of the cell site. In aspects, the radar presence detector determines the waveform is a radar waveform by comparing frequency bandwidth of the waveform to the wireless traffic waveform or pulse characteristics of the waveform to the wireless traffic waveform.

### BRIEF DESCRIPTION OF THE SEVERAL VIEWS OF THE DRAWINGS

Illustrative embodiments of the present invention are described in detail below with reference to the attached drawing figures, and wherein:

FIG. 1 depicts an example of a network environment in accordance with one or more embodiments;

FIG. 2 depicts a diagram of an example block diagram of components of the cell site configured to dynamically deactivate or adjust power of at least one radio of the cell site, in accordance with aspects herein;

FIG. 3 a flowchart of an exemplary method for dynamically deactivating or adjusting power of at least one radio of the cell site, in accordance with aspects herein; and

FIG. 4 depicts an exemplary computing device suitable for use in implementations of aspects herein.

### DETAILED DESCRIPTION

The subject matter of select embodiments of aspects herein is described with specificity herein to meet statutory requirements. But the description itself is not intended to define what we regard as our invention, which is what the claims do. The claimed subject matter might be embodied in other ways to include different steps or combinations of steps similar to the ones described in this document, in conjunction with other present or future technologies. Terms should not be interpreted as implying any particular order among or between various steps herein disclosed unless and except when the order of individual steps is explicitly described.

Throughout this disclosure, several acronyms and shorthand notations are used to aid the understanding of certain concepts pertaining to the associated system and services. These acronyms and shorthand notations are intended to help provide an easy methodology of communicating the ideas expressed herein and are not meant to limit the scope of aspects herein.

Embodiments herein may be embodied as, among other things: a method, system, or set of instructions embodied on one or more computer-readable media. Computer-readable media include both volatile and nonvolatile media, removable and nonremovable media, and contemplate media readable by a database, a switch, and various other network devices. Computer-readable media includes media implemented in any way for storing information. Examples of stored information include computer-useable instructions, data structures, program modules, and other data representations. Media examples include RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These technologies can store data momentarily, temporarily, or permanently. Embodiments may take the form of a hardware embodiment, or an embodiment combining software and hardware. Some embodiments may take the form of a computer-program product that includes computer-useable or computer-executable instructions embodied on one or more computer-readable media.

“Computer-readable media” can be any available media and may include volatile and nonvolatile media, as well as removable and non-removable media. By way of example, and not limitation, computer-readable media may include computer storage media and communication media.

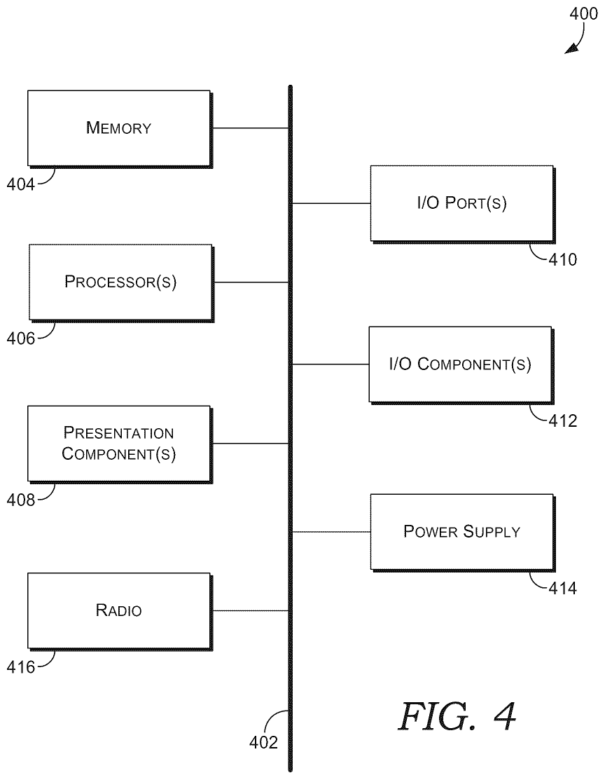

“Computer storage media” may include, without limitation, volatile and nonvolatile media, as well as removable and non-removable media, implemented in any method or technology for storage of information, such as computer-readable instructions, data structures, program modules, or other data. In this regard, computer storage media may include, but is not limited to, Random Access Memory (RAM), Read-Only Memory (ROM), Electrically Erasable Programmable Read-Only Memory (EEPROM), flash memory or other memory technology, CD-ROM, digital versatile disks (DVDs) or other optical disk storage, magnetic cassettes, magnetic tape, magnetic disk storage, or other magnetic storage devices, or any other medium which can be used to store the desired information and which may be accessed by the computing device 400 shown in FIG. 4. Computer storage media does not comprise a signal per se.

“Communication media” may include, without limitation, computer-readable instructions, data structures, program modules, or other data in a modulated data signal, such as a carrier wave or other transport mechanism, and may include any information delivery media. As used herein, the term “modulated data signal” refers to a signal that has one or more of its attributes set or changed in such a manner as to encode information in the signal. By way of example, and not limitation, communication media includes wired media such as a wired network or direct-wired connection, and wireless media such as acoustic, radio frequency (RF), infrared, and other wireless media. Combinations of any of the above also may be included within the scope of computer-readable media.

A “network” refers to a network comprised of wireless and wired components that provide wireless communications service coverage to one or more UE. The network may comprise one or more base stations, one or more cell sites (i.e., managed by a base station), one or more cell towers (i.e., having an antenna) associated with each base station or cell site, a gateway, a backhaul server that connects two or more base stations, a database, a power supply, sensors, and other components not discussed herein, in various embodiments.

The terms “base station” and “cell site” may be used interchangeably herein to refer to a defined wireless communications coverage area (i.e., a geographic area) serviced by a base station. It will be understood that one base station may control one cell site or alternatively, one base station may control multiple cell sites. As discussed herein, a base station is deployed in the network to control and facilitate, via one or more antenna arrays, the broadcast, transmission, synchronization, and receipt of one or more wireless signals in order to communicate with, verify, authenticate, and provide wireless communications service coverage to one or more UE that request to join and/or are connected to a network.

An “access point” may refer to hardware, software, devices, or other components at a base station, cell site, and/or cell tower having an antenna, an antenna array, a radio, a transceiver, and/or a controller. Generally, an access point may communicate directly with user equipment according to one or more access technologies (e.g., 3G, 4G, LTE, 5G, 6G, mMIMO) as discussed hereinafter.

A “band” is a specific frequency that a carriers utilizes to provide network coverage to its subscribers, enabling user devices corresponding to the subscribers to communicate with the particular network. An “adjacent band” refers to a band having a frequency range that is adjacent to the frequency range of the band.

The terms “user equipment,” “UE,” and “user device” are used interchangeably to refer to a device employed by an end-user that communicates using a network. UE generally includes one or more antenna coupled to a radio for exchanging (e.g., transmitting and receiving) transmissions with a nearby base station, via an antenna array of the base station. In embodiments, UE may take on any variety of devices, such as a personal computer, a laptop computer, a tablet, a netbook, a mobile phone, a smart phone, a personal digital assistant, a wearable device, a fitness tracker, or any other device capable of communicating using one or more resources of the network. UE may include components such as software and hardware, a processor, a memory, a display component, a power supply or power source, a speaker, a touch-input component, a keyboard, and the like. In embodiments, some of the UE discussed herein may include current UE capable of using 5G or 6G and having backward compatibility with prior access technologies, current UE capable of using 5G or 6G and lacking backward compatibility with prior access technologies, and legacy UE that is not capable of using 5G or 6G.

The terms “radio,” “controller,” “antenna,” and “antenna array” are used interchangeably to refer to one or more software and hardware components that facilitate sending and receiving wireless radio-frequency signals, for example, based on instructions from a base station. A radio may be used to initiate and generate information that is then sent out through the antenna array, for example, where the radio and antenna array may be connected by one or more physical paths. Generally an antenna array comprises a plurality of individual antenna elements. The antennas discussed herein may be dipole antennas, having a length, for example, of ¼, ½, 1, or 1 ½ wavelength. The antennas may be monopole, loop, parabolic, traveling-wave, aperture, yagi-uda, conical spiral, helical, conical, radomes, horn, and/or apertures, or any combination thereof. The antennas may be capable of sending and receiving transmission via FD-MIMO, Massive MIMO, 3G, 4G, 5G, 6G, and/or 802.11 protocols and techniques.

Additionally, it will be understood that terms such as “first,” “second,” and “third” are used herein for the purposes of clarity in distinguishing between elements or features, but the terms are not used herein to import, imply, or otherwise limit the relevance, importance, quantity, technological functions, sequence, order, and/or operations of any element or feature unless specifically and explicitly stated as such.

As additional technologies are introduced into wireless communications, the potential for interference between adjacent bands increases. For example, radar spectrum, utilized to provide 6G services, is adjacent to radar frequencies utilized in Airport Surveillance Radar (ASR), Next-Generation Radar (NEXRAD), and the like. If a radar radio is in close proximity with a radar signal, interference may occur in both systems.

To illustrate, assume a particular cell site includes a radar radio and is near an airport. It is common for airports to utilize surveillance radar to verify location of aircraft, identify objects in the air space, and avoid collisions. Airports also utilize similar radar systems to monitor weather conditions. The radar systems are typically mounted on a continually rotating antenna mounted on a tower. As the antenna rotates, the radar signal sweeps in the direction of the antenna. Interference occurs when the radar signal sweeps across the area covered by the radar radio signal. This can result in dropped calls for user devices receiving a signal from the cell site or worse, failure to avoid collisions or detect severe weather conditions.

Aspects herein provide for dynamically deactivating and reactivating a radio at a particular cell site based on a radio frequency interference. For example, antenna elements are designed for specific operating frequency band(s); however, antennas are fully capable of operating beyond these specific operating frequency band(s), even if not with optimum radiation characteristics. Rather than requiring dedicated design elements and sensors, aspects herein enable mitigation (i.e., deactivating and reactivating) to be achieved with existing base station equipment since detection of the presence of the ASR does not require optimum performance from the base station antenna at the radar frequency. The base band unit receives the signals and distinguishes radar pulse waveforms from normal wireless traffic. In this way, the intrinsic capability of the existing hardware is employed for the purpose of mitigating interference to the ASR without the need for external/dedicated equipment. Even though described herein as related to ASR, other technologies can be impacted by base station emissions including weather radars that monitor atmospheric conditions (e.g., wind shear), and the like, and embodiments discussed herein are equally relevant to any other technologies impacted by base station emissions. In aspects, the technology herein is applicable to any environment having concurrent operations of co-located but interfering RF systems (e.g., optical systems, acoustic systems, etc.).

In one aspect, a method is provided for deactivating and reactivating a radio of a cell site based on radio frequency interference. The method comprises detecting, at a radar presence detector of the cell site, a waveform. The method also comprises determining, at the radar presence detector of the cell site, the waveform is not a wireless traffic waveform. The method further comprises, based on the determining, dynamically deactivating or adjusting power, at a dynamic power module of the cell site, at least one radio of at least one antenna of the cell site.

In another aspect, computer-readable storage media having computer-executable instructions embodied thereon is provided that, when executed by one or more processors, cause the processors to perform a method. The method comprises detect, at a radar presence detector of a cell site, a waveform. The method also comprises determining, at the radar presence detector of the cell site, the waveform is not a wireless traffic waveform. The method further comprises, based on determining the waveform is not the wireless traffic waveform, dynamically deactivate or adjust power, at a dynamic power module of the cell site, of at least one radio of at least one antenna of the cell site.

In yet another aspect, a system for dynamically deactivating and reactivating a radio at a cell site based on radio frequency interference. The system comprises a cell site comprising a first plurality of antennas. The system also comprises a radar presence detector of the cell site that detects a waveform and determine the waveform is not a wireless traffic waveform. The system further comprises a dynamic power module of the cell site that, based on the radar presence detector of the cell site determining the waveform is not the wireless traffic waveform, dynamically deactivates or adjusts power at least one radio of at least one antenna of the plurality of antennas.

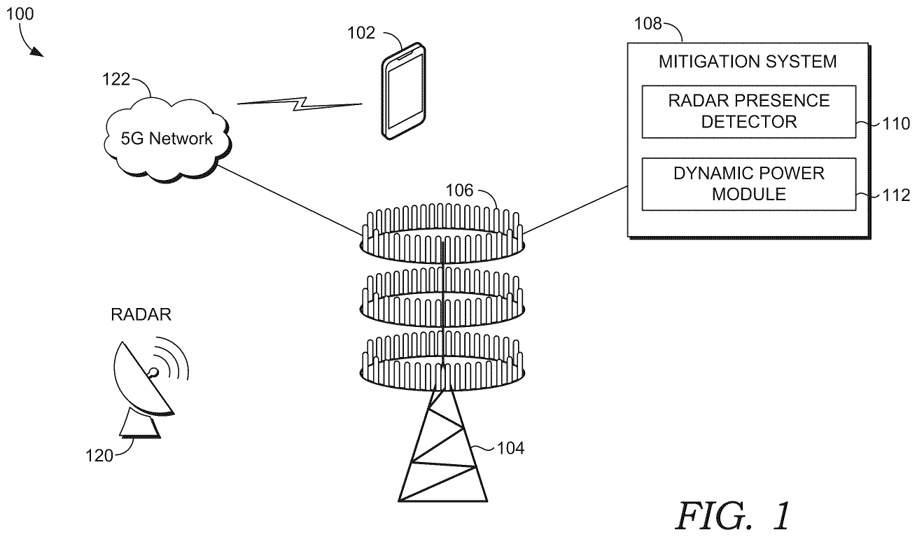

Turning to FIG. 1, a network environment suitable for use in implementing embodiments of the present disclosure is provided. Such a network environment is illustrated and designated generally as network environment 100. Network environment 100 is but one example of a suitable network environment and is not intended to suggest any limitation as to the scope of use or functionality of the disclosure. Neither should the network environment 100 be interpreted as having any dependency or requirement relating to any one or combination of components illustrated.

As previously mentioned, embodiments of the present invention are directed to dynamically deactivating and reactivating a radio at a cell site based on radio frequency interference. A network cell may comprise a base station to facilitate wireless communication between a communications device within the network cell, such as communications device 400 described with respect to FIG. 4, and a network. As shown in FIG. 1, a communications device may be a UE 102. In the network environment 100, UE 102 may communicate with other devices, such as mobile devices, servers, etc. The UE 102 may take on a variety of forms, such as a personal computer, a laptop computer, a tablet, a netbook, a mobile phone, a Smart phone, a personal digital assistant, or any other device capable of communicating with outer devices. For example, the UE 102 may take on any form such as, for example, a mobile device or any other computing device capable of wirelessly communication with the other devices using a network. Makers of illustrative devices include, for example, Research in Motion, Creative Technologies Corp., Samsung, Apple Computer, and the like. A device can include, for example, a display(s), a power source(s) (e.g., a battery), a data store(s), a speaker(s), memory, a buffer(s), and the like. In embodiments, UE 102 comprises a wireless or mobile device with which a wireless telecommunication network(s) can be utilized for communication (e.g., voice and/or data communication). In this regard, the UE 102 can be any mobile computing device that communicates by way of, for example, a 5G or 6G network.

The UE 102 may utilize network 122 to communicate with other computing devices (e.g., mobile device(s), a server(s), a personal computer(s), etc.). In embodiments, network 122 is a telecommunications network, or a portion thereof. A telecommunications network might include an array of devices or components, some of which are not shown so as to not obscure more relevant aspects of the invention. Components such as terminals, links, and nodes (as well as other components) may provide connectivity in some embodiments. Network 122 may include multiple networks, as well as being a network of networks, but is shown in more simple form so as to not obscure other aspects of the present disclosure. Network 122 may be part of a telecommunications network that connects subscribers to their immediate service provider. In embodiments, network 122 is associated with a telecommunications provider that provides services to user devices, such as UE 102. For example, network 122 may provide voice services to user devices or corresponding users that are registered or subscribed to utilize the services provided by a telecommunications provider. Although it is contemplated network 122 can be any communication network providing voice and/or data service(s), such as, for example, a 1x circuit voice, a 3G network (e.g., CDMA, CDMA 1000, WCDMA, GSM, UMTS), a 4G network (WiMAX, LTE, HSDPA), a 6G network, or the like, network 122 is depicted in FIG. 1 as a 5G network.

The network environment 100 may include a database (not shown). The database may be similar to the memory component 404 in FIG. 4 and can be any type of medium that is capable of storing information. The database can be any collection of records (e.g., network or device information). In one embodiment, the database includes a set of embodied computer-executable instructions that, when executed, facilitate various aspects disclosed herein. These embodied instructions will variously be referred to as “instructions” or an “application” for short.

As previously mentioned, the UE 102 may communicate with other devices by using a base station, such as base station 104. In embodiments, base station 104 is a wireless communications station that is installed at a fixed location, such as at a radio tower, as illustrated in FIG. 1. The radio tower may be a tall structure designed to support one or more antennas 106 for telecommunications and/or broadcasting. In other embodiments, base station 104 is a mobile base station. The base station 104 may be an MMU and include a gNodeB for 5G communications via network 122. In this way, the base station 104 can facilitate wireless communication between UE 102 and network 122.

As stated, the base station 104 may include a radio (not shown) or a remote radio head (RRH) that generally communicates with one or more antennas associated with the base station 104. In this regard, the radio is used to transmit signals or data to an antenna 106 associated with the base station 104 and receive signals or data from the antenna 106. Communications between the radio and the antenna 106 can occur using any number of physical paths. A physical path, as used herein, refers to a path used for transmitting signals or data. As such, a physical path may be referred to as a radio frequency (RF) path, a coaxial cable path, cable path, or the like.

The antenna 106 is used for telecommunications. Generally, the antenna 106 may be an electrical device that converts electric power into radio waves and converts radio waves into electric power. The antenna 106 is typically positioned at or near the top of the radio tower as illustrated in FIG. 1. Such an installation location, however, is not intended to limit the scope of embodiments of the present invention. The radio associated with the base station 104 may include at least one transceiver configured to receive and transmit signals or data.

Continuing, the network environment 100 may further include a mitigation system 108. The mitigation system 108 may be configured for, among other things, dynamically deactivating and reactivating a radio at a cell site based on radio frequency interference, in accordance with the present disclosure. Though mitigation system 108 is illustrated as a component of base station 104 in FIG. 1, it may be a standalone device (e.g., a server having one or more processors), a service provided via the 5G network 122, or may be remotely located.

As mentioned, the mitigation system 108 may facilitate dynamically deactivating and reactivating a radio at a cell site based on radio frequency interference, such as base station 104. The mitigation system 108 may include, among other things, a radar presence detector 110 and a dynamic power module 112.

The radar presence detector 110 may initially detect a waveform. In some aspects, the radar presence detector 110 determines the waveform is a radar waveform. For example, the radar presence detector 110 compares a frequency bandwidth of the waveform to the wireless traffic waveform. Additionally or alternatively, the radar presence detector 110 compares pulse characteristics of the waveform to the wireless traffic waveform. In some aspects, the radar presence detector 110 further identifies a dwell time of the waveform. The dwell time may correspond to a rotation speed and antenna pattern beam width of the at least one antenna and a distance of the at least one antenna to a source of the waveform. The radar presence detector 110 can take the form of hardware, software, or a combination thereof.

The dynamic power module 112 dynamically deactivates or adjusts power of at least one radio of at least one antenna of the plurality of antennas. In some aspects, upon the radar presence detector 110 no longer detecting the radar waveform, the dynamic power module 112 dynamically activates or adjusts power of the at least one radio of the at least one antenna of the plurality of antennas. In aspects, the base station antenna 106 can be active with an ability to form directional beams to cover/serve a specific area (e.g., a narrow angle in azimuth). As such, the dynamic power module 112 can dynamically activate/deactivate power of the at least one radio of the at least one antenna of the plurality of antennas while also being configured to adjust power of the at least one radio of the at least one antenna of the plurality of antennas. In other words, rather than momentarily disrupting (deactivating) transmissions for an entire sector, such beam forming implementations can deactivate only the beams pointed in the direction of the radar.

In other aspects, the base station 104 can quantify raw received power levels of RF signals and determine a distance of the base station 104 from the detected radar. Rather than completely discontinuing/deactivating transmission towards the direction of the detected radar, the base station 104 can adjust (e.g., reduce) the output power of the emission to a predetermined level. The emission can be adjusted to an output power that is a predetermined level below an interference threshold of the detected radar such that service for one or more users that are close to (i.e., within a predetermined distance) the base station 104 can be maintained.

Having described the network environment 100 and components operating therein, it will be understood by those of ordinary skill in the art that the network environment 100 is but one example of a suitable network and is not intended to limit the scope of use or functionality of aspects described herein. Similarly, the network environment 100 should not be interpreted as imputing any dependency and/or any requirements with regard to each component and combination(s) of components illustrated in FIG. 1. It will be appreciated by those of ordinary skill in the art that the number, interactions, and physical location of components illustrated in FIG. 1 are examples, as other methods, hardware, software, components, and devices for establishing one or more communication links between the various components may be utilized in implementations of the present invention. It will be understood to those of ordinary skill in the art that the components may be connected in various manners, hardwired or wireless, and may use intermediary components that have been omitted or not included in FIG. 1 for simplicity's sake. As such, the absence of components from FIG. 1 should not be interpreted as limiting the present invention to exclude additional components and combination(s) of components. Moreover, though components may be represented as singular components or may be represented in a particular quantity in FIG. 1, it will be appreciated that some aspects may include a plurality of devices and/or components such that FIG. 1 should not be considered as limiting the quantity of any device and/or component.

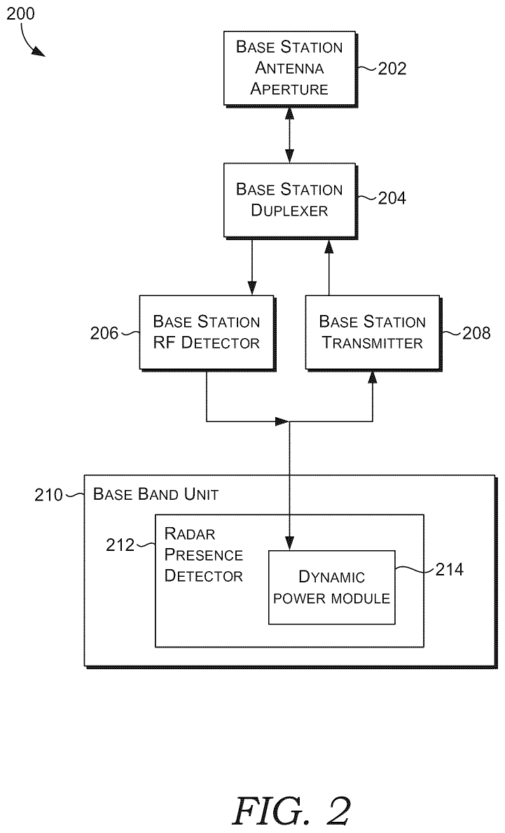

In FIG. 2, a diagram of example block diagram 200 of a cell site for dynamically deactivating and reactivating a radio at a cell site based on radio frequency interference is depicted. Initially, a base station antenna aperture 202 is configured to enable the cell site to communicate with mobile devices. To do so, base station antenna aperture 202 may use reflector antennas, horn antennas, or antenna arrays. In some aspects, multiple antennas share the base station antenna aperture 202, which may reduce the size of the cell site.

Base station duplexer 204 is configured to allow bi-directional (duplex) communication over a single path. In this way, base station duplexer 204 isolates the receiver from the transmitter while permitting the receiver and the transmitter to share a common antenna.

Base station RF detector 206 is configured to measure and control RF power at the cell site. The measurements enable the radar presence detector 212 to determine whether the waveform is a wireless traffic waveform or a radar waveform. Base station transmitter 208 is configured to receive instructions from the dynamic power module 214 to deactivate, adjust, and/or reactivate a radio of an antenna at the cell site. As illustrated, base band unit 210 at cell site is configured to include both radar presence detector 212 and dynamic power module 214. Moreover, the base band unit 210 can be configured to include each of the components without the need for external/dedicated equipment.

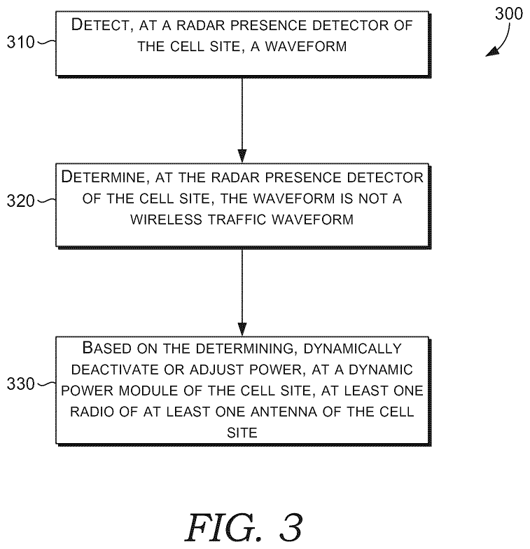

FIG. 3 depicts a flowchart of an exemplary method 300 for dynamically deactivating and reactivating a radio at a cell site based on radio frequency interference, in accordance with aspects herein. At block 310, a waveform is detected at a radar presence detector of the cell site. At block 320, the radar presence detector determines the waveform is not a wireless traffic waveform. For example, the radar presence detector may determine the waveform is a radar waveform. To do so, in one aspect, the radar presence detector may compare frequency bandwidth of the waveform to the wireless traffic waveform. In another aspect, the radar presence detector may compare pulse characteristics of the waveform to the wireless traffic waveform.

In some aspects, the radar presence detector identifies a dwell time of the waveform. The dwell time may correspond to a rotation speed and antenna pattern beam width of the at least one antenna of the cell site. The dwell time may further correspond to a distance of the at least one antenna of the cell site to a source of the waveform.

At block 330, a dynamic power module of the cell site dynamically deactivates or adjusts power of at least one radio of at least one antenna of the cell site. In some aspects, upon the radar presence detector no longer detecting the radar waveform, the dynamic power module dynamically activates or adjusts power of the at least one radio of the at least one antenna of the plurality of antennas.

Referring to FIG. 4, a block diagram of an example of a computing device 400 suitable for use in implementations of the technology described herein is provided. In particular, the exemplary computer environment is shown and designated generally as computing device 400. Computing device 400 is but one example of a suitable computing environment and is not intended to suggest any limitation as to the scope of use or functionality of the invention. Neither should computing device 400 be interpreted as having any dependency or requirement relating to any one or combination of components illustrated. In aspects, the computing device 400 may be a base station. In another embodiment, the computing device 400 may be UE capable of two-way wireless communications with an access point. Some non-limiting examples of the computing device 400 include a base station, a controller at a base station, a backhaul server, a personal computer, a cell phone, current UE, legacy UE, a tablet, a pager, a personal electronic device, a wearable electronic device, an activity tracker, a laptop, and the like.

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

As shown in FIG. 4, computing device 400 includes a bus 402 that directly or indirectly couples various components together. The bus 402 may directly or indirectly one or more of memory 404, processor(s) 406, presentation component(s) 408 (if applicable), radio(s) 416, input/output (I/O) port(s) 410, input/output (I/O) component(s) 412, power supply 414, and/or transmitter(s) 418. Although the components of FIG. 4 are shown with lines for the sake of clarity, in reality, delineating various components is not so clear, and metaphorically, the lines would more accurately be grey and fuzzy. For example, one may consider a presentation component(s) 408 such as a display device to be one of I/O components 412. Also, the processor(s) 406 may include memory 404, in another example. The present disclosure hereof recognizes that such is the nature of the art, and reiterates that FIG. 4 is merely illustrative of an example of a computing device 400 that can be used in connection with one or more implementations of the present disclosure. Distinction is not made between such categories as “workstation,” “server,” “laptop,” “handheld device,” etc., as all are contemplated within the scope of the present disclosure and refer to “computer” or “computing device.”

Memory 404 may take the form of memory components described herein. Thus, further elaboration will not be provided here, but it should be noted that memory 404 may include any type of tangible medium that is capable of storing information, such as a database or data store. A database or data store may be any collection of records, files, or information encoded as electronic data and stored in memory 404, for example. In one embodiment, memory 404 may include a set of embodied computer-readable and executable instructions that, when executed, facilitate various functions or elements disclosed herein. These embodied instructions will variously be referred to as “instructions” or an “application” for short.

Processor(s) 406 may be multiple processors that receive instructions and process them accordingly. Presentation component(s) 408, if available, may include a display device, an audio device such as a speaker, and/or other components that may present information through visual (e.g., a display, a screen, a lamp (LED), a graphical user interface (GUI), and/or even lighted keyboards), auditory, and/or other tactile or sensory cues.

Radio(s) 416 represents one or more radios that facilitate communication with a wireless telecommunications network. For example, radio(s) 416 may be connected to one or more antenna elements through a physical path. Illustrative wireless telecommunications technologies include CDMA, GPRS, TDMA, GSM, and the like. Radio(s) 416 might additionally or alternatively facilitate other types of wireless communications including Wi-Fi, WiMAX, 4G, 5G, LTE, mMIMO, NR, VoLTE, and/or other VoIP communications. As can be appreciated, in various embodiments, radio(s) 416 can be configured to concurrently support multiple technologies, as previously discussed herein. As such, each of many radio(s) 416 may be used to separately control portions of an antenna array, for example, where at least one portion utilizes a distinct technology relative to another portion in the same antenna array or at the same base station or cell site. A wireless telecommunications network might include an array of devices, which are not shown so as to not obscure more relevant aspects of the invention. Components such as a base station, a communications tower, or even access points (as well as other components) can provide wireless connectivity in some embodiments.

The input/output (I/O) ports 410 may take a variety of forms. Exemplary I/O ports 412 may include a USB jack, a stereo jack, an infrared port, a firewire port, other proprietary communications ports, and the like. Input/output (I/O) components 412 may comprise keyboards, microphones, speakers, touchscreens, and/or any other item usable to directly or indirectly input data into the computing device 400.

Power supply 414 may include batteries, fuel cells, and/or any other component that may act as a power source to supply power to the computing device 400 or to other network components, including through one or more electrical connections or couplings. Power supply 414 may be configured to selectively supply power to different components independently and/or concurrently.

Finally, regarding FIGS. 1 through 4, it will be understood by those of ordinary skill in the art that the environment(s), system(s), and/or methods(s) depicted are not intended to limit the scope of use or functionality of the present embodiments. Similarly, the environment(s), system(s), and/or methods(s) should not be interpreted as imputing any dependency and/or any requirements with regard to each component, each step, and combination(s) of components or step(s) illustrated therein. It will be appreciated by those having ordinary skill in the art that the connections illustrated the figures are contemplated to potentially include methods, hardware, software, and/or other devices for establishing a communications link between the components, devices, systems, and/or entities, as may be utilized in implementation of the present embodiments. As such, the absence of component(s) and/or steps(s) from the figures should be not be interpreted as limiting the present embodiments to exclude additional component(s) and/or combination(s) of components. Moreover, though devices and components in the figures may be represented as singular devices and/or components, it will be appreciated that some embodiments can include a plurality of devices and/or components such that the figures should not be considered as limiting the number of devices and/or components.

It is noted that aspects of the present invention are described herein with reference to block diagrams and flowchart illustrations. However, it should be understood that each block of the block diagrams and/or flowchart illustrations can be implemented in the form of a computer program product, an entirely hardware embodiment, a combination of hardware and computer program products, and/or apparatus, systems, computing devices/entities, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code can be performed sequentially such that one instruction is retrieved, loaded, and executed at a time. In some embodiments, retrieval, loading, and/or execution can be performed in parallel such that multiple instructions are retrieved, loaded, and/or executed together. Thus, such embodiments can produce specifically-configured machines performing the steps or operations specified in the block diagrams and flowchart illustrations. Accordingly, the block diagrams and flowchart illustrations support various combinations of embodiments for performing the specified instructions, operations, or steps.

Additionally, as should be appreciated, various embodiments of the present disclosure described herein can also be implemented as methods, apparatus, systems, computing devices/entities, computing entities, and/or the like. As such, embodiments of the present disclosure can take the form of an apparatus, system, computing device, computing entity, and/or the like executing instructions stored on a computer-readable storage medium to perform certain steps or operations. However, embodiments of the present disclosure can also take the form of an entirely hardware embodiment performing certain steps or operations.

Many different arrangements of the various components depicted, as well as components not shown, are possible without departing from the scope of the claims below. Embodiments of our technology have been described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

The invention claimed is:

1. A method for dynamically deactivating and reactivating a radio of a cell site based on radio frequency (RF) interference, the method comprising:
detecting, at a radar presence detector of the cell site, a waveform;
determining, at the radar presence detector of the cell site, the waveform is not a wireless traffic waveform; and
based on the determining, dynamically deactivating or adjusting power, at a dynamic power module of the cell site, at least one radio of at least one antenna of the cell site.

2. The method of claim 1, further comprising, determining, at the Radar presence detector, the waveform is a radar waveform.

3. The method of claim 2, wherein the determining comprises comparing frequency bandwidth of the waveform to the wireless traffic waveform.

4. The method of claim 1, wherein the determining comprises comparing pulse characteristics of the waveform to the wireless traffic waveform.

5. The method of claim 1, further comprising identifying, at the radar presence detector, a dwell time of the waveform.

6. The method of claim 5, wherein the dwell time corresponds to a rotation speed and antenna pattern beam width of the at least one antenna of the cell site.

7. The method of claim 6, wherein the dwell time further corresponds to a distance of the at least one antenna of the cell site to a source of the waveform.

8. Computer-readable storage media having computer-executable instructions embodied thereon that, when executed by one or more processors, cause the processors to:
detect, at a radar presence detector of a cell site, a waveform;
determine, at the radar presence detector of the cell site, the waveform is not a wireless traffic waveform; and
based on determining the waveform is not the wireless traffic waveform, dynamically deactivate or adjust power, at a dynamic power module of the cell site, of at least one radio of at least one antenna of the cell site.

9. The media of claim 8, further comprising, determining, at the Radar presence detector, the waveform is a radar waveform.

10. The media of claim 9, wherein the determining comprises comparing frequency bandwidth of the waveform to the wireless traffic waveform.

11. The media of claim 8, wherein the determining comprises comparing pulse characteristics of the waveform to the wireless traffic waveform.

12. The media of claim 8, further comprising identifying, at the radar presence detector, a dwell time of the waveform.

13. The media of claim 12, wherein the dwell time corresponds to a rotation speed and antenna pattern beam width of the at least one antenna of the cell site.

14. The media of claim 13, wherein the dwell time further corresponds to a distance of the at least one antenna of the cell site to a source of the waveform.

15. A system for dynamically deactivating and reactivating a radio at a cell site based on radio frequency (RF) interference, the system comprising:
a cell site comprising a plurality of antennas;
a radar presence detector of the cell site that detects a waveform and determine the waveform is not a wireless traffic waveform; and
a dynamic power module of the cell site that, based on the radar presence detector of the cell site determining the waveform is not the wireless traffic waveform, dynamically deactivates or adjusts power of at least one radio of at least one antenna of the plurality of antennas.

16. The system of claim 15, wherein the radar presence detector further determines the waveform is a radar waveform.

17. The system of claim 16, wherein the determining comprises comparing frequency bandwidth of the waveform to the wireless traffic waveform.

18. The system of claim 15, wherein the determining comprises comparing pulse characteristics of the waveform to the wireless traffic waveform.

19. The system of claim 15, wherein the radar presence detector further identifies a dwell time of the waveform.

20. The system of claim 19, wherein the dwell time corresponds to a rotation speed and antenna pattern beam width of the at least one antenna and a distance of the at least one antenna to a source of the waveform.
